(19) United States
(12) Patent Application Publication
(10) Pub. No.: US 2011/0216931 A1
(43) Pub. Date: Sep. 8, 2011

(54) MODULAR WIRELESS ELECTRONIC COMMUNICATION SYSTEM

(76) Inventor: Le Bui, Tustin, CA (US)

(21) Appl. No.: 13/037,627

(22) Filed: Mar. 1, 2011

Related U.S. Application Data
(60) Provisional application No. 61/309,855, filed on Mar. 2, 2010.

(51) Int. Cl. H04R 9/06

(52) U.S. Cl. 381/333

(57) ABSTRACT

Electronic communication devices are disclosed that are configured in the form of a personal accessory. The devices preferably include a communication module and at least one ear speaker operably connected to the communication module through at least one wire. The invention provides that the communication module enables wireless communication with another device, e.g., cellular telephones, digital data players, etc. The communication module is preferably concealed behind a first disguising component. The at least one wire of the device is also concealed within or runs contiguous with another disguising component.

### CROSS-REFERENCE TO RELATED APPLICATIONS

This application claims priority to, and incorporates by reference, U.S. provisional patent application Ser. No. 61/309,855, filed Mar. 2, 2010.

### FIELD OF THE PRESENT INVENTION

The field of the present invention relates to wireless communication devices and, more specifically, to modular wireless communication systems that are worn by users and resemble jewelry or other personal accessories.

### BACKGROUND OF THE INVENTION

Wireless communication devices have become an important and, indeed, necessary part of everyday life. The evolution of the cellular telephone and other wireless communication devices allows individuals to remain in constant contact with each other at any particular time, regardless of geographical location. In recent years, advancements have been made to enhance the usability and, in some cases, the aesthetic appeal of such electronic communication devices.

For example, the development of BlueTooth® technology (an RF-based, peer-to-peer wireless communication platform) allows users to talk to each other via a wireless connection, in a “hands-free” manner, through a cellular telephone (or other communication device). Devices that employ BlueTooth® technology are often worn by a user around his or her ear, in proximity to a cellular telephone or other communication device. While these devices have provided a reliable means to talk with another person via a wireless connection, in a “hands-free” manner, the devices lack preferred aesthetic appeal. For this reason, others have attempted to develop wireless communication devices, which allow users to talk with another person in a “hands-free” manner, whereby the devices are disguised or camouflaged to the ordinary viewer. Despite such currently-available devices, a need exists for improved wireless communication devices that allow users to talk with each other in a “hands-free” manner, which are preferably adorned in such a way that causes the devices to resemble the look of jewelry or other personal accessories. Preferably, such improved devices will be modular, such that the means by which the devices are adorned may be easily adjusted to accommodate the wants and desires of the user.

As described below, the invention described herein addresses such needs, and provides many other benefits over the wireless communication devices that are currently available in the market place.

### SUMMARY OF THE INVENTION

According to certain aspects of the present invention, electronic communication devices are provided, which are configured in the form of a personal accessory. The devices preferably comprise a communication module and at least one ear speaker operably connected to the communication module through at least one wire. The invention provides that the communication module enables wireless communication with another device, e.g., cellular telephones, digital data players, etc.

In addition, the invention provides that the communication module is concealed behind a first disguising component, such that the communication module may be reversibly separated from the first disguising component and connected to a second disguising component. In other words, the invention provides that the communication module may be interchangeably connected to any of a plurality of disguising components. As such, a user may select the disguising component that is most visually appealing to such user, e.g., a disguising component that resembles an attractive piece of jewelry, such as a necklace/pendant combination. Still further, according to certain preferred embodiments, the invention provides that at least one wire of the device is concealed within or runs contiguous with a third disguising component. For example, the wire that connects the communication module to the ear speaker is preferably adorned with a disguising component that imparts the look of a personal accessory, such as a necklace or other personal accessories.

The invention provides that the modular electronic communication devices of the present invention may exhibit any number of additional features. For example, the invention provides that the devices may comprise a mechanical or magnetic means for allowing the communication module to be easily and securely connected to any of various disguising components, e.g., jewelry modules that may be used to conceal the communication module. In addition, the mechanical or magnetic means may further be configured to prevent the communication module from undesirably disengaging the disguising component, e.g., using hooks, snaps, magnets, threads, bayonets, and/or combinations thereof.

The invention provides that the wireless communication device may be equipped with any combination of additional features. For example, the invention encompasses having the device employ the use of voice controls, software, and/or an accelerometer to allow users to operate the device. The invention further provides that a clip may be used, in order to allow the adorned wire of the device to be worn in different configurations, as shown and described herein. According to certain embodiments, the device may further employ the use of sub-modules for additional functionality, such as a data storage and transmission sub-module, a clock/watch sub-module, a medical monitoring sub-module, and others. According to still further embodiments, the device may comprise: a light-emitting means to enhance the aesthetics of the device, the ability to charge the device via inductive energy transfer, and/or a signal booster to enhance the performance of the device.

The above-mentioned and additional features of the present invention are further illustrated in the Detailed Description contained herein.

### BRIEF DESCRIPTION OF THE FIGURES

FIG. 1A is an illustration of a non-limiting example of a wireless communication device of the present invention.

FIG. 1B is an illustration showing the device of FIG. 1A being worn by a person.

FIG. 2A is a disassembled view of a non-limiting example of a wireless communication device of the present invention.

FIG. 2B is a disassembled view of the communication module and disguising component (jewelry module) described herein.

FIG. 3A is a diagram of the communication module described herein.

FIG. 3B is a disassembled view of the communication module of FIG. 3A.

FIG. 3C is a diagram that illustrates the various two-dimensional shapes that the communication module of the device may exhibit.

FIG. 4A is an illustration of a non-limiting example of a disguising component (jewelry module), applied to a communication module.

FIG. 4B is a non-limiting example of a communication module shell (jewelry shell), as described herein.

FIG. 4C is a diagram showing the various two-dimensional shapes that the disguising component may exhibit.

FIG. 5A is a diagram showing a headphone connector and communication module.

FIG. 5B includes certain images of a variety of headphone connectors that may be used with the device of the present invention.

FIG. 6A is a diagram showing how the communication module shell may be used to retain the headphone connector in the communication module.

FIG. 6B is another diagram showing the means by which hooks, snaps, magnets, threads, or bayonets may be used to retain the headphone connector in the communication module.

FIG. 7 is a diagram showing various ways in which the wires of the communication device may be worn, with or without the use of a clip.

FIG. 8A-C includes several diagrams showing the various components and layers of an earphone that may be used with the device of the present invention.

FIG. 9A-D includes several drawings showing how a non-limiting example of a communication device of the present invention may be configured and worn by a person.

FIG. 10A is a diagram showing a non-limiting example of a communication device of the present invention, along with separate sub-modules.

FIG. 10B is a diagram showing various sub-modules operably connected to the communication device shown therein.

FIG. 11A is a front view of the communication device, showing how illumination may be employed to enhance the aesthetic appeal of the device.

FIG. 11 B is a side view of the communication device of FIG. 11A.

FIG. 12 is a side view of a communication device that comprises a retractable spring therein, which may be used to retract and store the wire of the device within the main unit or communication module.

FIG. 13A-B includes certain drawings of a communication device of the present invention configured as a choker-style piece of jewelry.

FIG. 14A is a drawing showing a communication device having retractable wire coils, being worn by a person.

FIG. 14B is a topside view of the retractable wire component of the device shown in FIG. 14A.

FIG. 15A-B includes several drawings showing a communication device of the present invention configured as necktie.

FIG. 16 includes certain drawings that show how the communication device of the present invention may be charged via induction.

FIG. 17 is a diagram that shows how an area signal booster may be used to enlarge the space in which the communication device of the present invention may be effectively operated.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

As shown and described below, the invention generally comprises a “modular wireless electronic communication system,” which is sometimes referred to herein as the “MWECS” or the “device.” The MWECS is an interchangeable electronic communication device that generally comprises an adorned main unit (the so-called communication module) and disguising component (which may be a jewelry module, as described herein). The MWECS further comprises adorned wires that are operably connected to at least one earphone. The various components of the MWECS are preferably interchangeable, such that a communication module may be reversibly fitted with any of a variety of different disguising components (or decorative jewelry modules). The MWECS device may employ BlueTooth® technology, or other RF-based communication platforms, as a primary communication protocol. The MWECS device may be used for a variety of applications, including two-way communication through telephones, two-way communication to music and recording devices, and the others described herein.

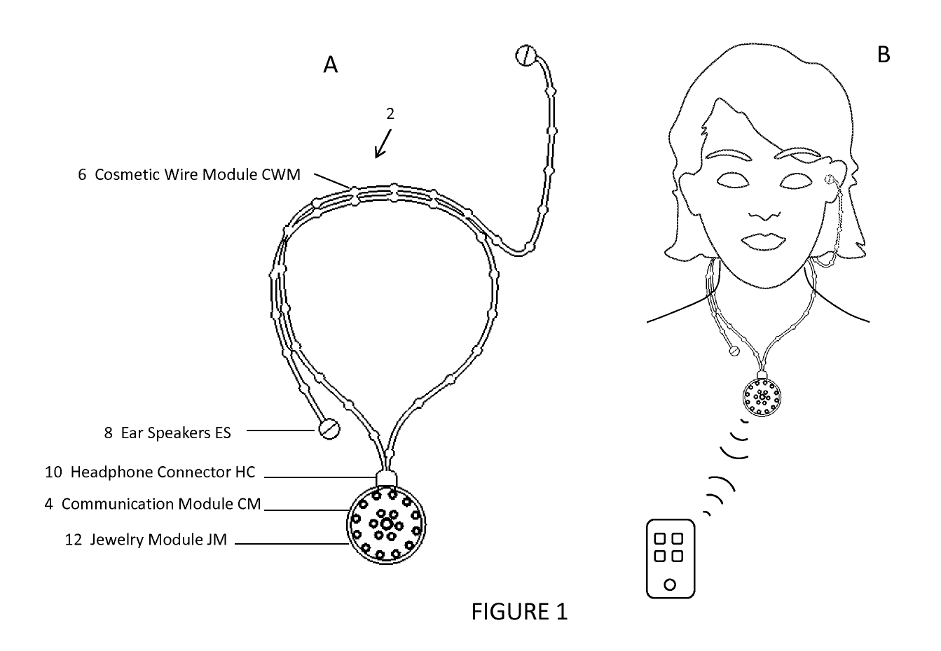

Referring now to FIG. 1A, a non-limiting example of a modular wireless electronic communication system (MWECS) 2 of the present invention is shown. As illustrated therein, the MWECS includes a communication module 4 and wires connected thereto 6, which are both adorned to enhance the aesthetic appeal of the MWECS. In addition, the MWECS comprises at least one ear speaker 8, which is operably connected to the communication module 4 vis-à-vis the wires 6. In this embodiment, the wires 6 are configured to operably and reversibly engage the communication module 4 through a headphone connector 10. The invention provides that the communication module 4 and wires 6 are preferably adorned, to disguise such components and create a look of a personal accessory, such as a piece of jewelry.

FIG. 1B illustrates a non-limiting example of the MWECS being worn by a person, and communicating with a cellular telephone. Although the device shown in FIG. 1 is configured and disguised as a necklace/pendant, the device may be configured in many other ways, such as pendants, earrings, hair clips, hair bandanas, hair barrettes, hair pins, hair claws, hair clamps, headbands, hair combs, hair sticks, bobby pins, hair forks, pony tail holders, chains, nose rings, pins/brooches, and in other forms.

The wires 6 may be adorned using a type of cosmetic outer shell, which encapsulates and routes the electric wires 6 between the communication module 4 and at least one ear speaker 8. For example, two insulated (and adorned) wires 6 may be routed between the communication module 4 and at least one ear speaker 8, to create a closed circuit. In certain embodiments, for example, the cosmetic outer shell may be comprised of (A) a braided leather piece or rope (bolo) which has a hollow core to channel the wires 6 therein; (B) beads, gems, pearls, or other precious stones having a drilled core to channel wires 6 therein; (C) a metal multi-chain, with each metal chain being used as an electrical conductor to create the necessary closed circuit system; (D) a metal snake chain, having a hollow core to channel the wires 6; (E) a sewn fabric tube, which creates a hollow core to channel the wires 6; or (F) a molded electric wire 6, wherein the exterior insulation jacket for the electrical wires are colored or shaped to mimic gems, stones, pearls, chains, or other jewelry-like accessories.

The invention provides that the MWECS may be configured to provide a variety of functions, such as two-way communication with telephones, two-way communication with music and recording devices, for data storage and transmission purposes, for storage and transmission of electricity, for time keeping purposes, medical monitoring and notification purposes, audio recordation purposes, personal notification functions (e.g., time, exercise routines, temperature, etc.), personal record and password storage, electronic payment facilitation applications, global position satellite (GPS) functions, video and image capturing functions, and others.

There are many benefits provided by the MWECS. For example, to name just a few, the MWECS represents a small and inconspicuous device that allows a person to communicate with others (and/or carryout any of the other functions mentioned above), while wearing the MWECS in a manner that emulates a piece of jewelry or other personal accessories. In addition, because the communication module 4 and wires 6 are modular and may be interchanged with others, or otherwise provided with different disguising components (jewelry modules) 12, the MWECS is flexible and may be easily adapted to the likes and dislikes of the user. Needless to say, the MWECS also provides certain safety benefits, such as allowing a user to operate the MWECS, in a “hands-free” manner, while carrying out other important functions, such as driving an automobile.

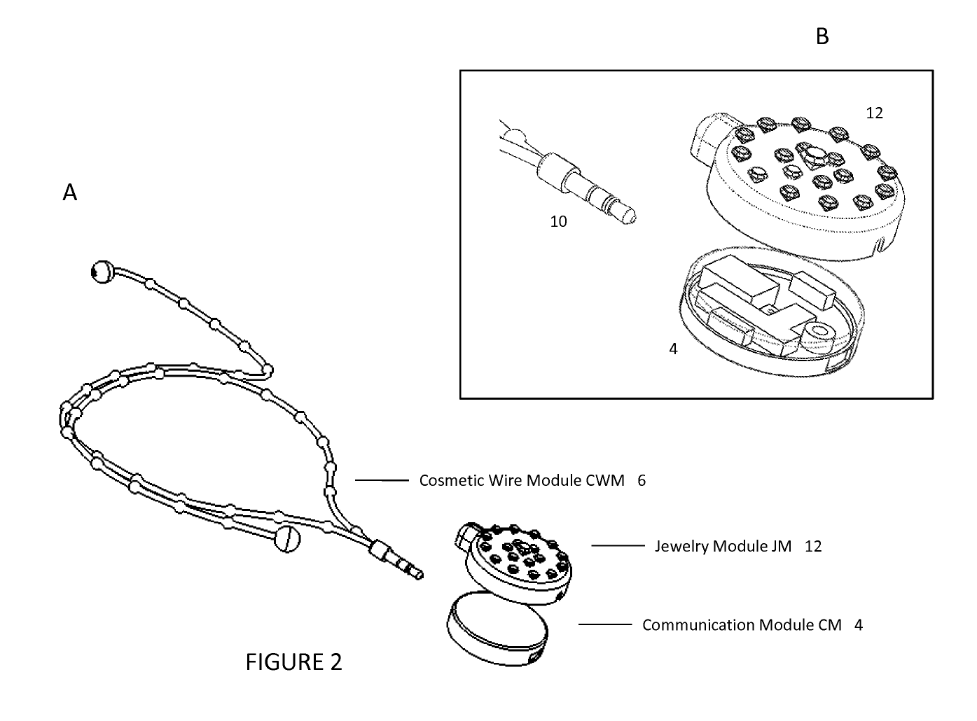

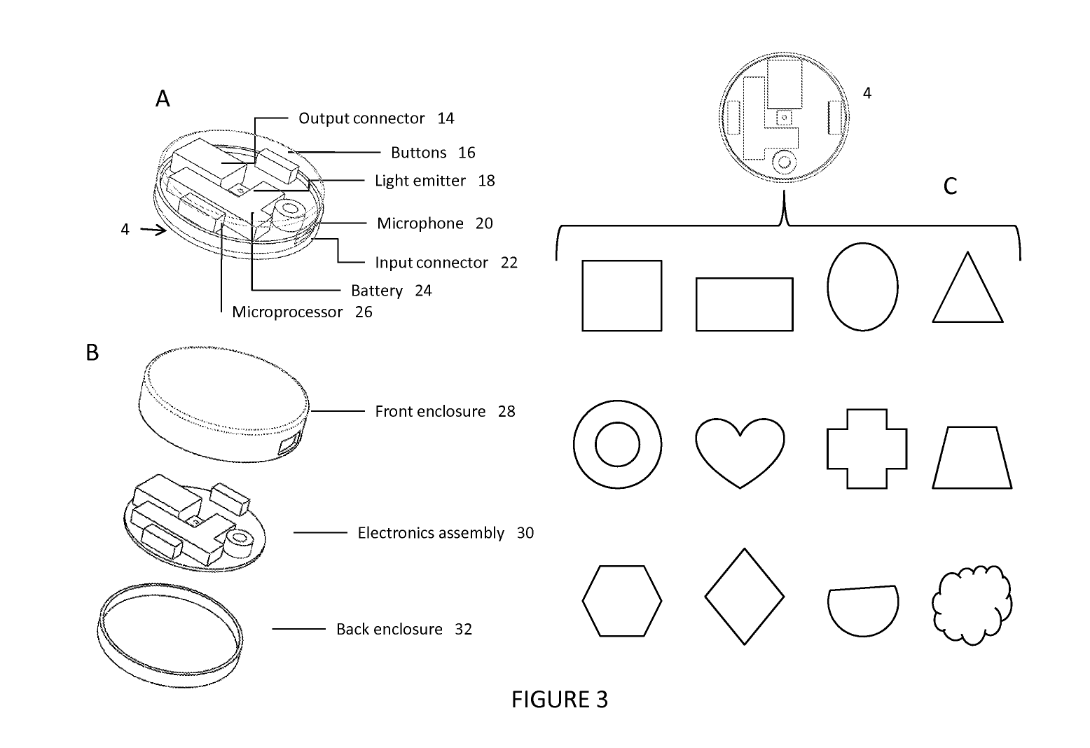

Referring now to FIG. 2A, another view of a non-limiting example of a MWECS is provided, which shows the communication module 4 separated from the disguising component (jewelry module) 12. FIG. 2B illustrates the same MWECS, and further provides a transparent view of the inner part of the communication module 4. Referring now to FIG. 3A, another view of the communication module 4 is provided, with a transparent front side, so that the inner components thereof may be viewed. Specifically, the communication module 4 comprises an output connector 14 (which is adapted to reversibly receive a headphone connector 10), buttons 16 for carrying out certain user-activated functions (such as turning the power on/off, adjusting volume, answering a phone call, etc.), a light emitter 18 (which may be used for cosmetic purposes, to notify the user of the power state of the device, to notify the user of whether a phone call has been received, to notify the user of whether a voice mail has been recorded, etc.), a microphone 20 (which is adapted to receive and wirelessly transmit the user's voice to another device), an input connector 22 (which may be used to operably connect a sub-module (as described) herein or another device to the communication module 4), a battery 24, and a microprocessor 26 (which may comprise software another means for executing the various functions provided by the device). In certain embodiments, the buttons 16 may be used to input demands and other information by a user. In certain other embodiments, however, the device may comprise voice controls and software, which may provide a means to instruct the device to carryout a certain function, without having to manually input data or instructions using the buttons 16. In addition, the invention provides that the device may be provided with an accelerometer sensor, which may be configured to detect the tilt, acceleration and movement of a user, whereby such information may be used to instruct the device to carryout a defined function.

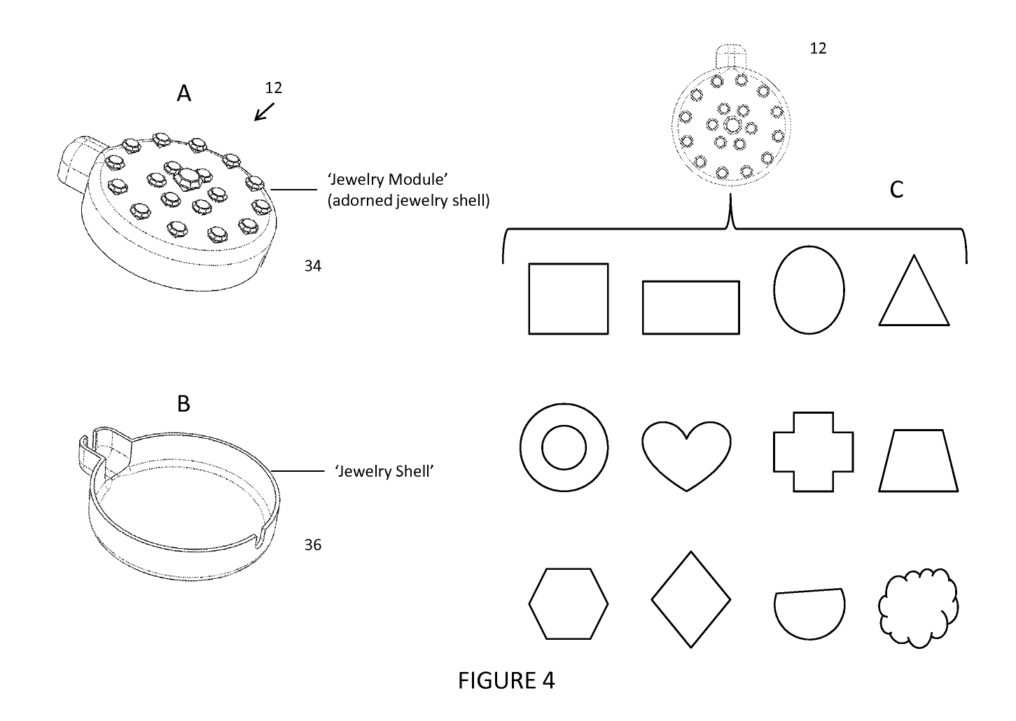

Referring now to FIG. 3B, the macro-components of the communication device are illustrated therein, including a front enclosure 28, the electronics assembly 30 on which the various parts referenced above are affixed, and a back enclosure 32. The invention provides that the communication module 4 may exhibit any of a variety of different two-dimensional and three-dimensional shapes. For example, referring to FIG. 3C, the communication module 4 may exhibit any of the two-dimensional (cross-sectional shapes) shown therein, in accordance with the preferences of the user. The invention provides that the disguising component (or jewelry module) 12 should be configured in such a manner that it can receive and/or encapsulate the communication module 4. For example, the disguising component (or jewelry module) 12 shown in FIG. 4 includes a top decorative and adorned portion 34 (FIG. 4A), which is complementary in size and shape with a bottom portion 36. In this example, the invention provides that the disguising component (or jewelry module) 12 shown in FIGS. 4A and 4B will be adapted to encapsulate and disguise a substantially round communication module 4. As mentioned with respect to the communication module 4, the disguising component (or jewelry module) 12 may be configured in any of a variety of shapes and sizes (as shown in FIG. 4C), provided that it is adapted to securely be connected to and disguise a communication module 4.

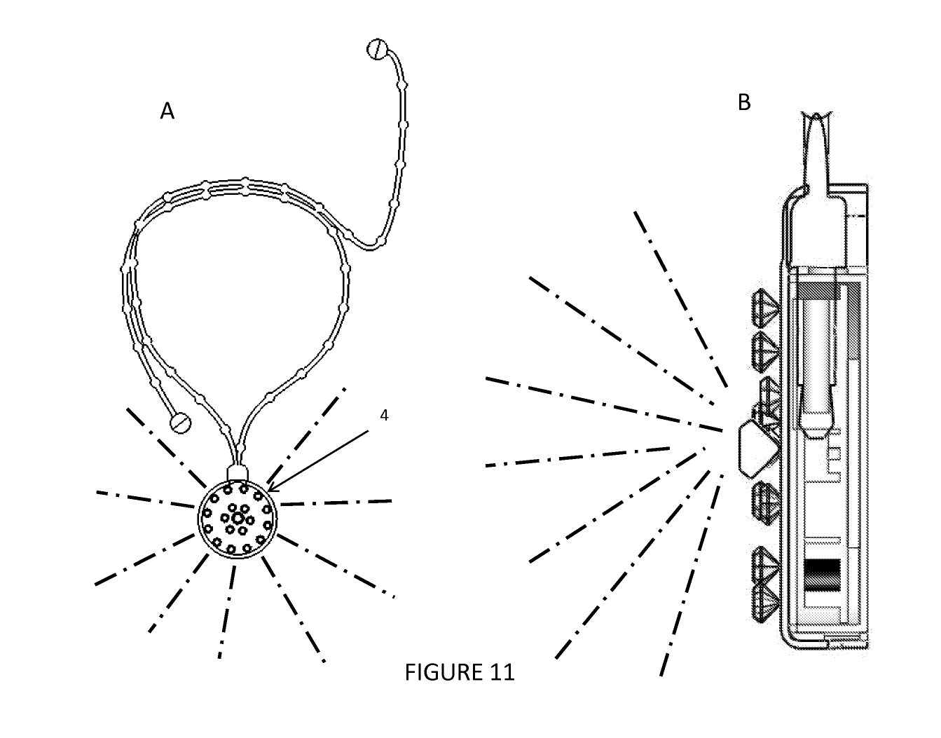

The invention provides that the disguising component (or jewelry module) 12 will preferably comprise a means for reversibly and securely attaching a communication module 4 thereto, such as snap features, latch features, spring retention features, threaded features, twist lock bayonet features, magnets, friction fit features, and others. The invention provides that the disguising component (or jewelry module) 12 may be comprised of any suitable and desirable material (e.g., different types of metals, plastics, polymers), and may further be provided with any of a variety of different decorative elements (e.g., different types of gems, stones, etc.). Such components may be manufactured using any suitable means, including, but not limited to, stamping methods, forging, casting, investment casting, lost wax methods, sintering, deposition methods, material printing methods, metal injection molding, and others. In addition, as illustrated in FIG. 11, the device may be equipped with certain light-emitting means, such as LEDs, to further enhance the aesthetic appearance of the device. For example, the communication module 4 may comprise one or more LEDs housed therein, which emit light from the communication module 4 and through one or more stones, prisms, or other elements—to enhance the aesthetic appeal of the device.

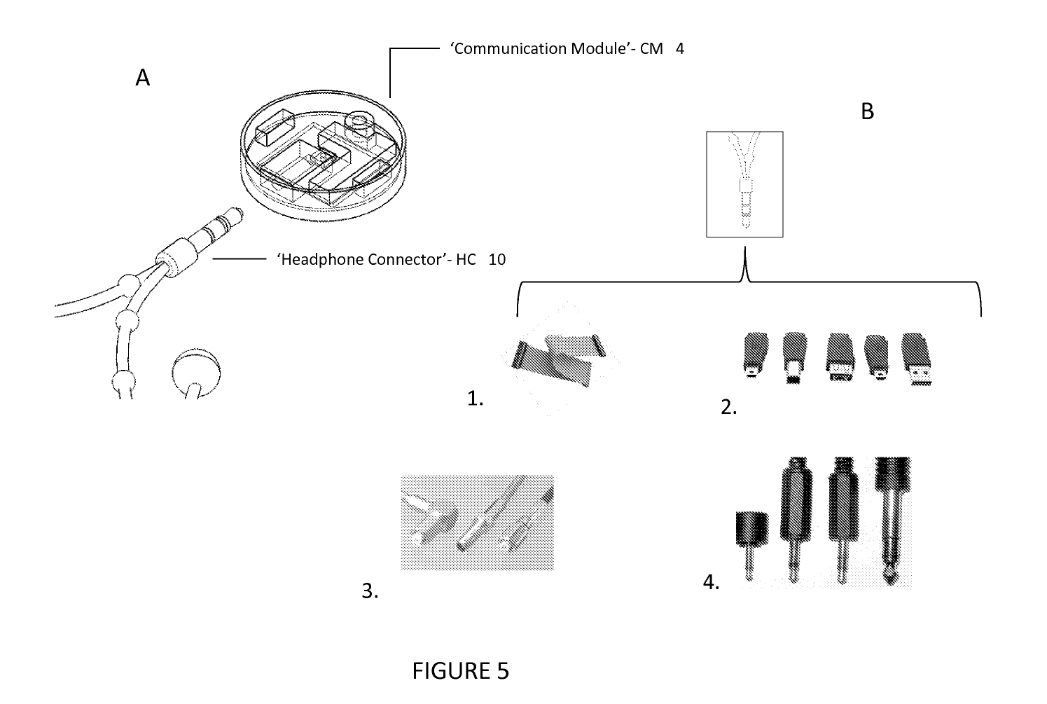

Referring now to FIG. 5, the invention provides that the headphone connector 10 that is inserted into the communication module 4 may be configured in a variety of ways. For example, as illustrated in FIG. 5B, the headphone connector 10 may be configured as (1) flex or ribbon connectors, (2) USB connectors of all types, (3) audio jack connectors of all sizes and types, and (4) any other type of custom connector. The invention provides that the port into which the headphone connector 10 may be inserted will preferably be adapted to receive and be connected to any of various devices, such as headphones or power supplies.

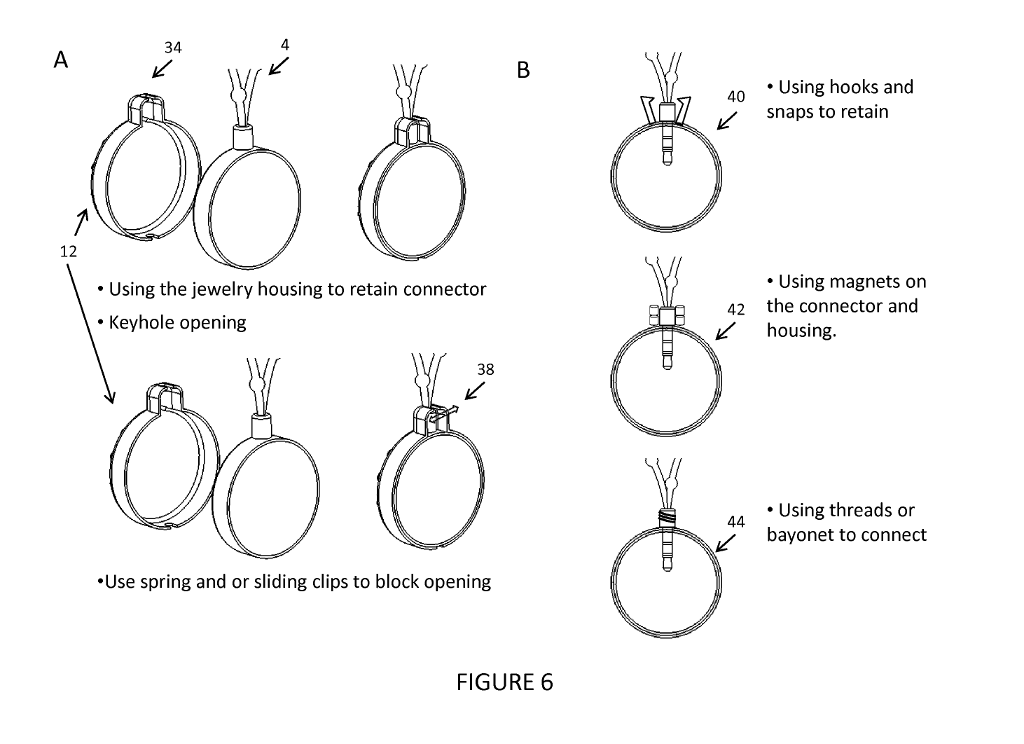

Referring now to FIG. 6A, as mentioned above, the invention provides that the disguising component (or jewelry module) 12 will preferably comprise a means for reversibly and securely attaching the communication module 4 thereto. FIG. 6A shows the front, adorned portion 34 of the disguising component (or jewelry module) 12 receiving a communication module 4. In this example, the top-most portion of the front, adorned portion 34 is configured to mechanically secure the communication module 4 and headphone connector 10 combination thereto, e.g., vis-à-vis a key-hole opening. This configuration may be enhanced by further employing the use of a spring or sliding clip 38 to secure these components to the front, adorned portion 34 of the disguising component (or jewelry module) 12. In certain alternative embodiments, and referring to FIG. 6B, the disguising component (or jewelry module) 12 may be equipped with hooks 40, magnets 42, and/or threading means 44 at the top-most portion of the disguising component (or jewelry module) 12, in order to provide a further means for securely and reversibly attaching the disguising component (or jewelry module) 12 to the communication module 4.

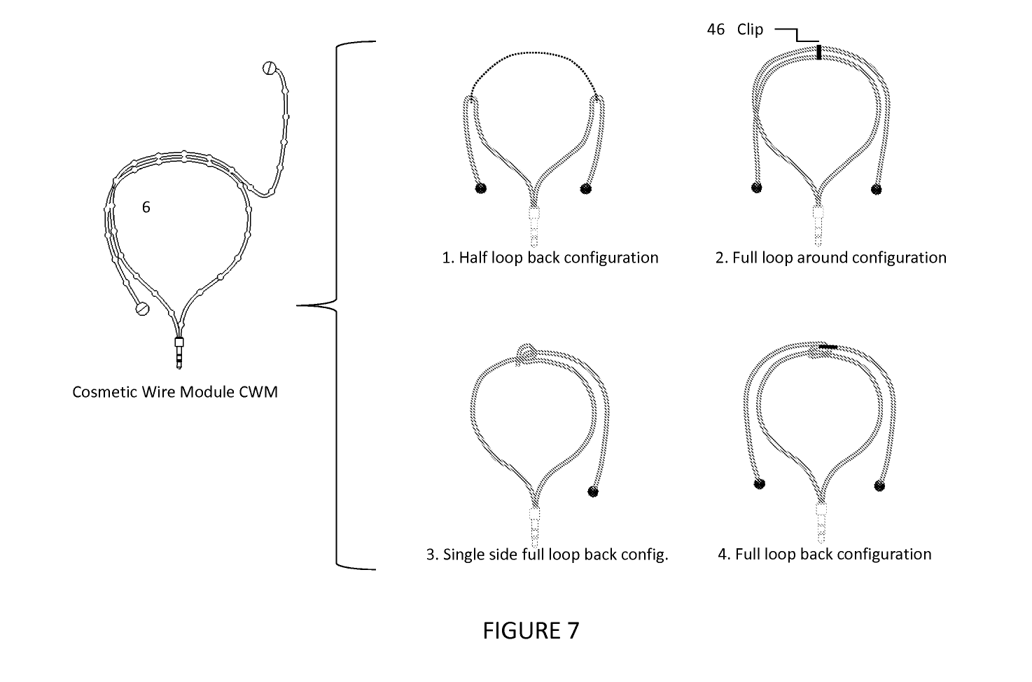

The invention provides that the MWECS may be worn in any of various ways. For example, FIG. 7 illustrates various ways in which the adorned wires 6 of the MWECS may be configured and worn, in certain instances using a clip 46 to secure the wires 6 in the desired position. More particularly, referring to FIG. 7, the adorned wires 6 of the MWECS may be worn in any of the following configurations: (1) in a half-loop back configuration (which may employ the use of an additional chain to create a complete loop around the user's neck); (2) a full loop around configuration (which wraps around the user's neck and employs a clip 46 to hold the wires together); (3) a single side full loop back configuration (in which only one side loops behind the user's neck); and (4) a full loop back configuration (in which two sides loop back behind the user's neck).

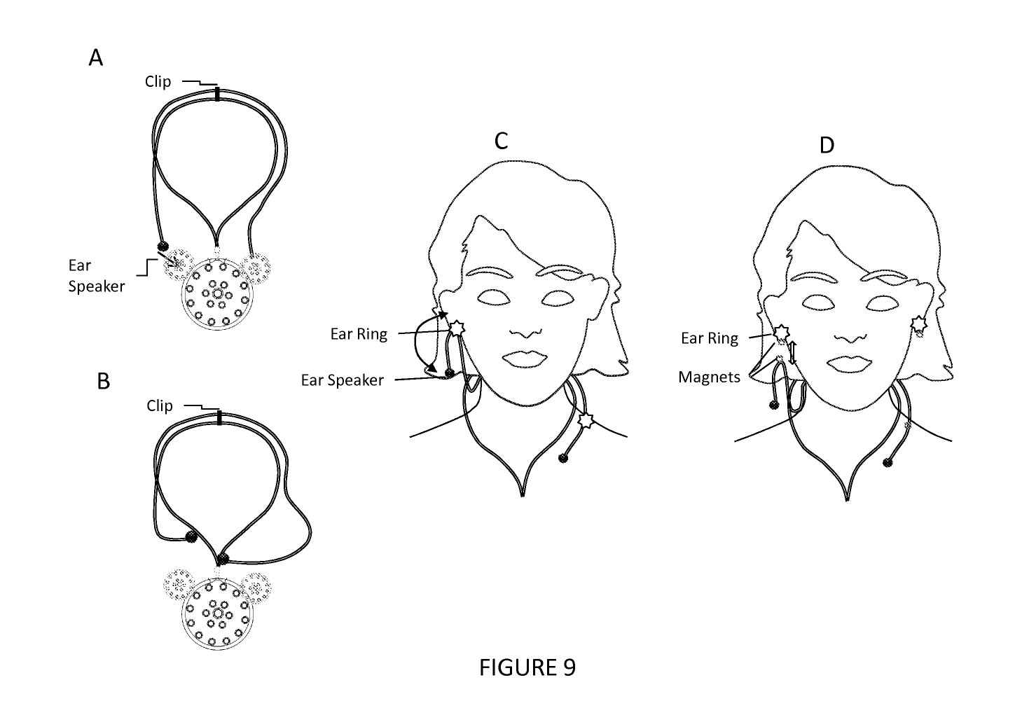

FIG. 9 provides yet further examples of how the MWECS may be configured and worn by a person. More particularly, referring to FIG. 9A, the MWECS may be worn by a person in a way that the wires 6 are positioned behind the disguising component (jewelry module) 12. FIG. 9B illustrates how the ear speakers of the MWECS may be docked at any desired location, using snaps, hooks, magnets, and other fastening means. FIG. 9C illustrates the means by which an earring may be incorporated into the wires 6, in order to provide a mounting location on the user's ear lobe. The invention provides that this configuration positions the earphones closer to the user's ear, thereby making it easier to place the earphone into the ear of the user (during operation). FIG. 9D illustrates an alternate configuration showing an earring that independently mounts on the user's ear, with the wire 6 assembly comprising additional features (such as magnets, clips, hooks, snaps, etc.), which may be easily attached to (and detached from) the earring. The invention provides that such feature prevents earrings from being accidentally pulled from a user's ear.

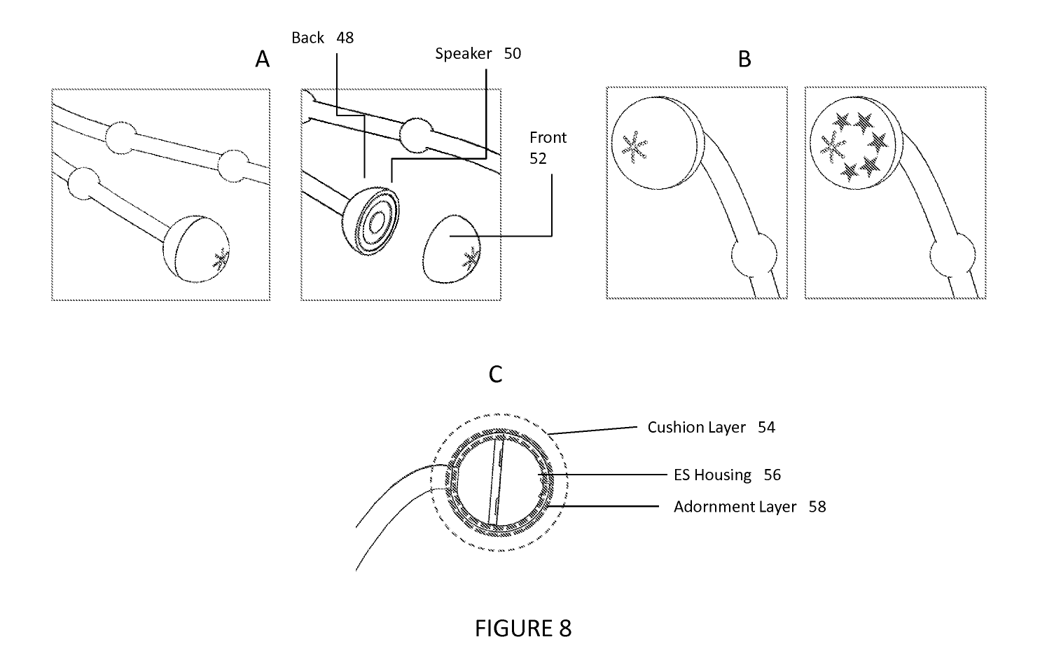

Referring now to FIG. 8, the invention provides that the earphones used in connection with the MWECS may be configured in various ways. In certain preferred embodiments of the present invention, the earphones will comprise a back portion 48 that will preferably comprise a speaker 50. In this example, a decorative front portion 52 may be attached to the back portion, and interchanged with other different-looking front portions 52. The front portion 52 may be comprised of any desired material, including precious metals, polymers, gems, stones, and combinations thereof. This way, a user may select the type of front portion 52 that the user desires to wear. Referring to FIG. 8C, the earphone may comprise different sub-parts and layers, namely, a cushion layer 54 that is soft and designed to be comfortable to wear by a user, an ear speaker housing area or component 56, and an adornment layer 58 that is configured to receive and be connected to a corresponding adorned front portion 52 of the earphone. The invention provides that the front portion 52 and back portion 48 of the earphone may be mechanically and/or magnetically reversibly attached to each other.

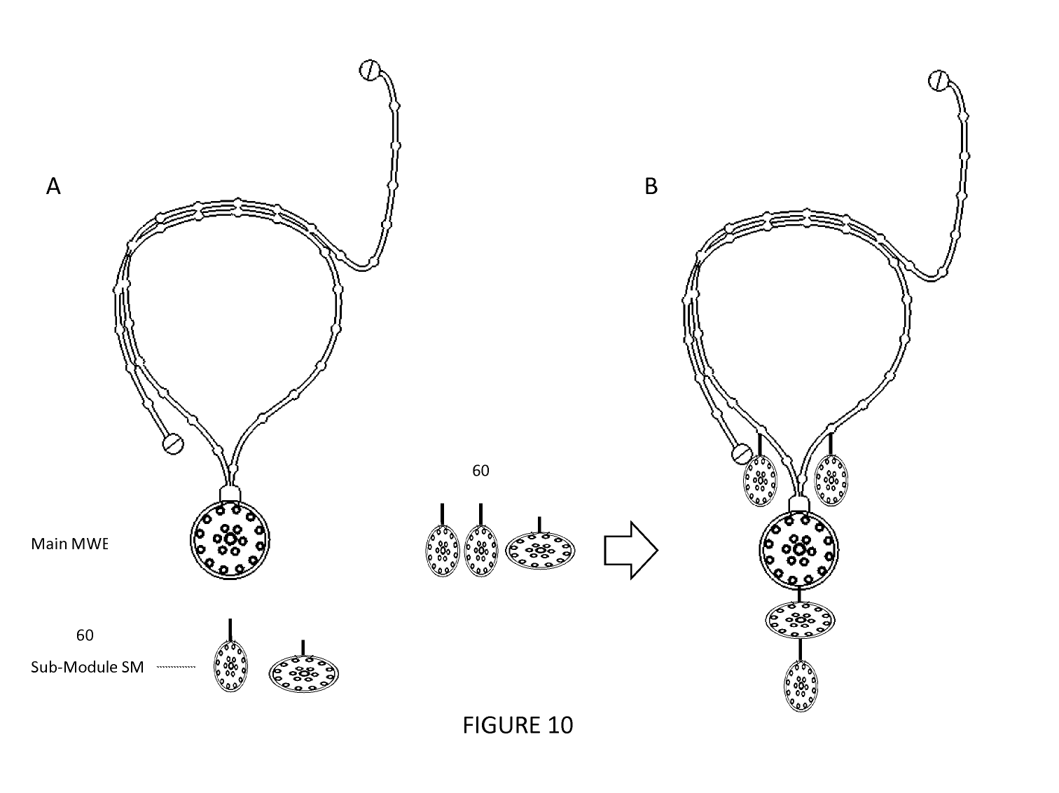

According to certain embodiments, the MWECS may comprise one or more sub-modules 60, which may be operably connected to the communication module 4. For example, referring to FIG. 10, the invention provides that a user may select one or more sub-modules 60, with each performing one or more additional functions, to be operably connected to the MWECS. The invention provides that the sub-modules 60 may be selected by the user in accordance with his/her personal needs. For example, as mentioned above, the invention provides that a sub-module 60 may be configured to provide any of the following additional functionalities: data storage and transmission functions, additional electricity storage and transmission functions, time keeping functions, medical monitoring functions (e.g., heart rate, blood sugar, pace maker monitoring, hearing aid functionalities, etc.), loud speaker functions, vibration notification purposes, light source functions, audio recording and playback functions, personal record and password storage, electronic payment facilitation applications, global position satellite (GPS) functions, video and image capturing functions, and others.

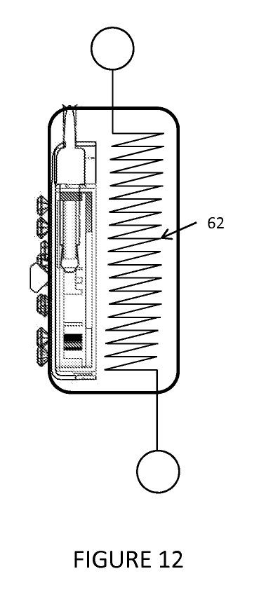

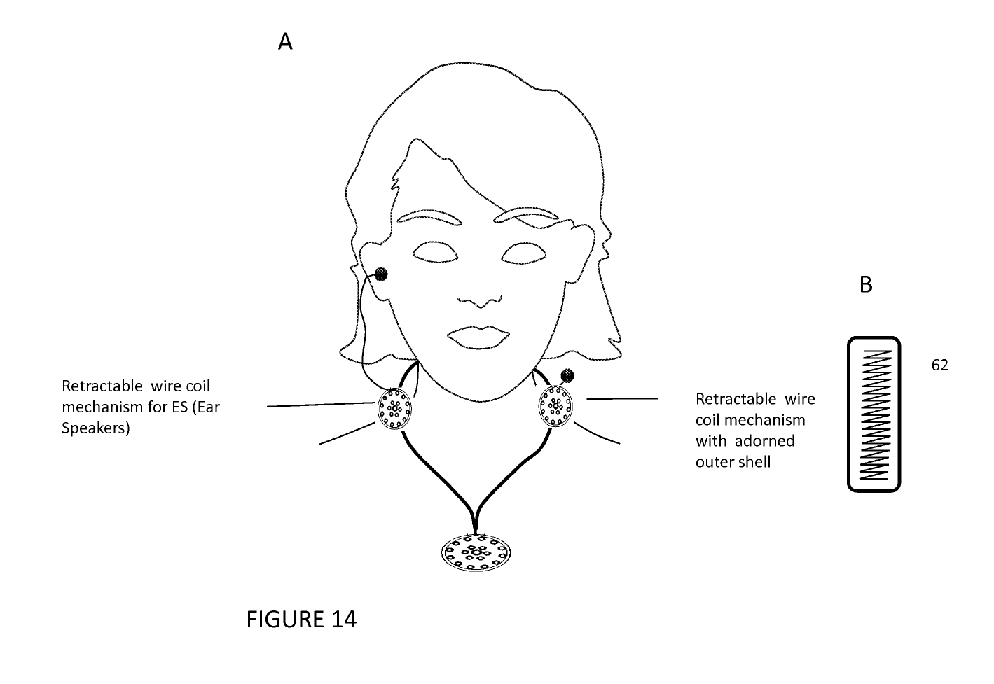

Referring now to FIG. 12, the invention provides that the MWECS of the present invention may, optionally, comprise a retractable coil mechanism 62. The retractable coil mechanism 62 is preferably configured to withdraw the wires 6 into the MWECS, when desired by the user. FIG. 14 provides yet another example of how a retractable coil mechanism 62 may be employed in the MWECS, to allow a user to position earphones adjacent to his/her ear during operation of the device, and allow the associated wires to retract into an adorned shell (e.g., resembling the look of an earring) when the device is not being used.

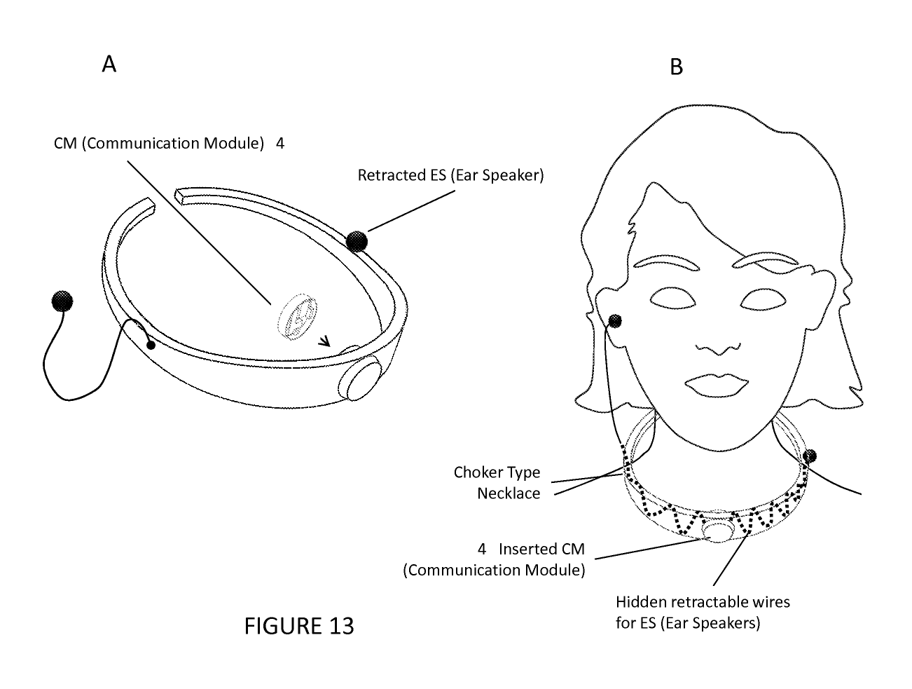

Although the MWECS of the present invention has primarily been described and illustrated herein to exhibit the shape and configuration of a necklace and pendant, the invention provides that other designs may be employed. For example, FIG. 13 provides an illustration of the MWECS in the form of a choker-style piece of jewelry. As illustrated therein, the MWECS may comprise the retractable wires referenced above, so that the earphone may be placed adjacent to a user's ear during operation (and allowed to retract back into the device following usage). As with the other embodiments described herein, the choker-style MWECS may be comprised of any desirable materials, and adorned with precious metals, gems, stones, polymers, and other desirable items. In this example, the communication module 4 is adorned and positioned in the approximate front, center portion of the device—within a correspondingly-shaped pocket or recessed area of the choker.

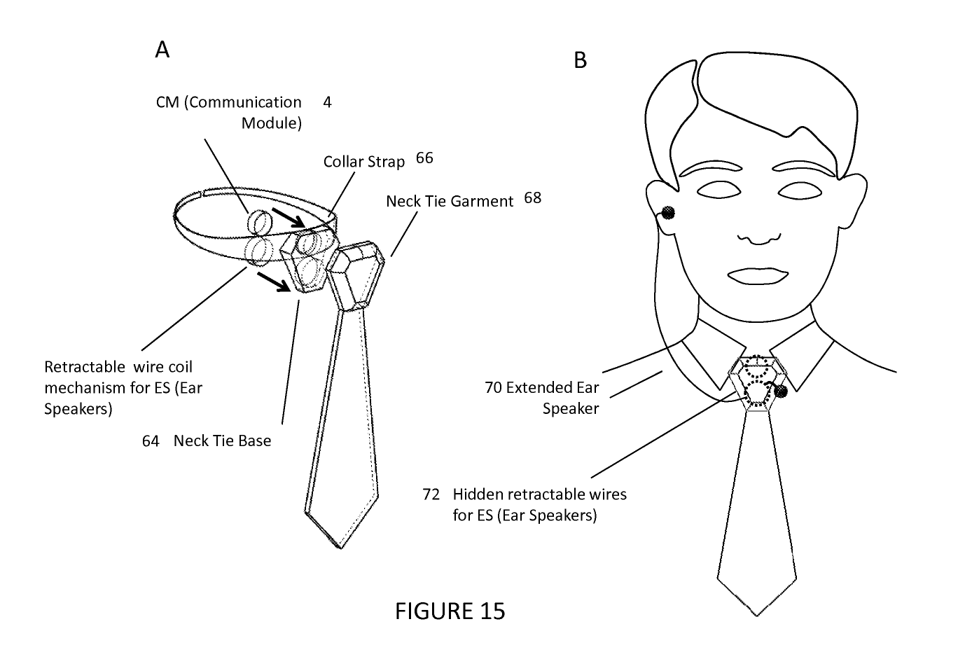

By way of further example, the MWECS may be configured in the form of a necktie. An example of such configuration is illustrated in FIG. 15. More particularly, for example, when the MWECS is configured in the form of a necktie, the device may comprise a collar strap 66 that surrounds the user's neck, and may be applied to a user's neck and secured thereto using snaps, magnets, hooks, buttons, or other connecting means (such that a user may “open” the collar strap 66 to position the same around his neck, and then reversibly close the strap 66 around his neck once it has been placed into position). The collar strap will preferably comprise a neck tie base 64, which houses a communication module 4. According to such embodiments, the invention provides that a necktie garment 68 may serve as a disguising component 12, which may be reversibly attached to the neck tie base 64. The invention provides that the necktie garment 68 may be comprised of any desired material, e.g., silk or other polymers, and may exhibit any of a variety of visual designs (thereby allowing a user to select the necktie garment 68 that is most aesthetically desirable). According to such embodiments, the MWECS may comprise an earphone 70 that is connected to a retractable wire 72, such that the earphone 70 may be positioned in the proximity of the user's ear during operation, and retracted back to the communication module 4 or neck tie base 64 when the device is not being used.

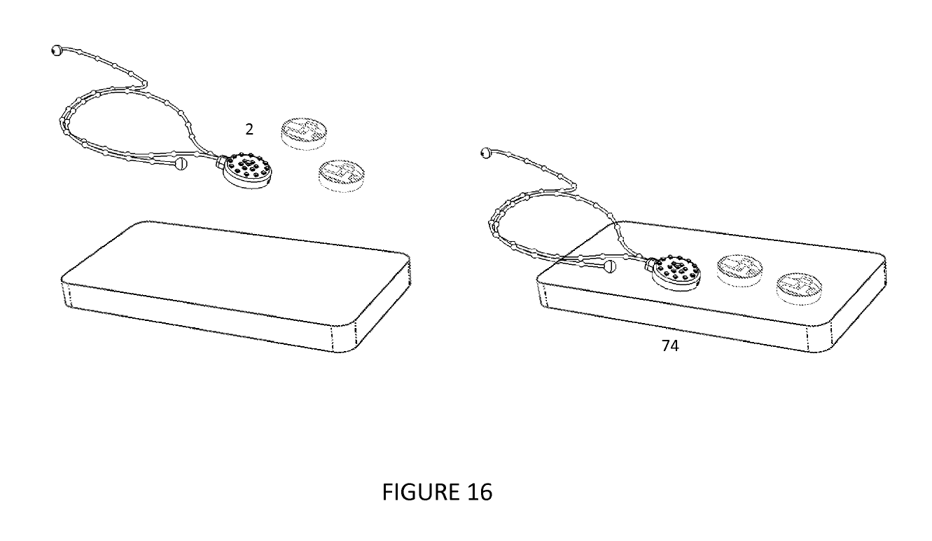

The invention provides that the battery 24 of the MWECS may be provided with an electrical charge via a connection between the MWECS and a standard wall outlet, e.g., using a dedicated MWECS charger. In certain alternative embodiments, however, the MWECS may be charged, and electricity may be provided to the battery 24, vis-à-vis inductance charging. For example, referring to FIG. 16, the invention further encompasses an inductive charging platform 74 on which the device 2 may be located during charging. According to such methods, the inductive charging platform 74 is configured to transfer an electrical charge to the device 2, when the device 2 is placed on (or in close proximity to) the inductive charging platform 74. Of course, in this embodiment, the device 2 may be electrically charged without establishing a direct connection between the inductive charging platform 74 and the device 2.

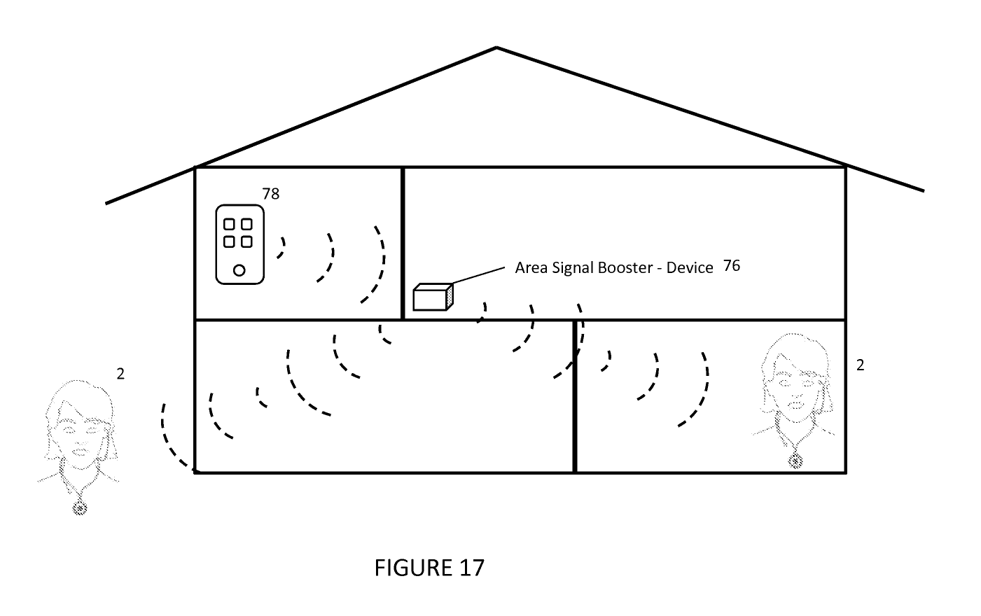

According to still further embodiments of the present invention, the MWECS may comprise an area signal booster 76. Most electronic devices that employ RF/BlueTooth® technology to enable wireless communication have a range of operation of about 30 feet. Referring to FIG. 17, the invention provides that an area signal booster 76 may be employed to allow a person to use the MWECS device 2 a greater distance from another electronic communication device 78, such as a cellular phone. Such embodiments will help to increase the radius of operation for the device 2, relative to another electronic communication device 78. Still further, the invention provides that multiple signal boosters 76 may be employed (and spaced apart from each other), such that the plurality of signal boosters 76 may, collectively, significantly increase the radius of operation for the device 2.

Although illustrative embodiments of the present invention have been described herein, it should be understood that the invention is not limited to those described, and that various other changes or modifications may be made by one skilled in the art without departing from the scope or spirit of the invention.

What is claimed is:

1. An electronic communication device that is configured in the form of a personal accessory, which comprises a communication module and at least one ear speaker operably connected to said communication module through at least one wire, wherein:
(a) the communication module enables wireless communication with another device;
(b) the communication module is concealed behind a first disguising component, wherein the communication module may be reversibly separated from the first disguising component and connected to a second disguising component; and
(c) the at least one wire is concealed within or runs contiguous with a third disguising component.

2. The electronic communication device of claim 1, wherein the at least one wire is retractable and may be extended from, or retracted into, the device.

3. The electronic communication device of claim 1, which further comprises one or more sub-modules operably connected thereto, wherein each of the one or more sub-modules are configured to carryout a function selected from the group consisting of:
data storage and transmission functions, electricity storage and transmission functions, time keeping functions, medical monitoring functions, loud speaker functions, vibration notification functions, light source functions, audio recording and playback functions, personal record and password storage, electronic payment facilitation applications, global position satellite (GPS) functions, and video and image capturing functions.

4. The electronic communication device of claim 1, which further comprises a light-emitting means.

5. The electronic communication device of claim 1, which further comprises a means for reversibly securing the communication module to the first disguising component.

6. The electronic communication device of claim 1, which further comprises a battery that may be charged through inductive energy transfer.

7. An electronic communication device that is configured in the form of jewelry, which comprises a communication module and at least one ear speaker operably connected to said communication module through at least one wire, wherein:
(a) the communication module enables wireless communication with another device and comprises a set of controls that allow a user to activate the device and adjust a volume of sound that emanates from the ear speaker, wherein the set of controls comprises buttons operably connected to the communication module, a voice control means embedded with the communication module, or an accelerometer sensor;
(b) the communication module is concealed behind a first jewelry component, wherein the communication module may be reversibly separated from the first jewelry component and connected to a second jewelry component; and
(c) the at least one wire is concealed within or runs contiguous with a third jewelry component.

8. The electronic communication device of claim 7, wherein the at least one wire is retractable and may be extended from, or retracted into, the device.

9. The electronic communication device of claim 8, which further comprises one or more sub-modules operably connected thereto, wherein each of the one or more sub-modules are configured to carryout a function selected from the group consisting of:
data storage and transmission functions, electricity storage and transmission functions, time keeping functions, medical monitoring functions, loud speaker functions, vibration notification functions, light source functions, audio recording and playback functions, personal record and password storage, electronic payment facilitation applications, global position satellite (GPS) functions, and video and image capturing functions.

10. The electronic communication device of claim 9, which further comprises a light-emitting means.

11. The electronic communication device of claim 10, which further comprises a means for reversibly securing the communication module to the first jewelry component.

12. The electronic communication device of claim 11, which further comprises a battery that may be charged through inductive energy transfer.

13. An electronic communication device that is configured in the form of jewelry, which comprises a communication module and at least one ear speaker operably connected to said communication module through at least one wire, wherein the at least one wire is operably connected to a spring housed within the communication module, such that a majority of the at least one wire may be retracted inside the communication module, wherein:
(a) the communication module enables wireless communication with another device and comprises a set of controls that allows a user to activate the device and adjust a volume of sound that emanates from the ear speaker, wherein the set of controls comprise buttons operably connected to the communication module, a voice control means embedded with the communication module, or an accelerometer sensor;
(b) the communication module is concealed behind a first jewelry component, wherein the communication module may be reversibly separated from the first jewelry component and connected to a second jewelry component; and
(c) the at least one wire is concealed within or runs contiguous with a third jewelry component.

14. The electronic communication device of claim 13, which further comprises one or more sub-modules operably connected thereto, wherein each of the one or more sub-modules are configured to carryout a function selected from the group consisting of:
data storage and transmission functions, electricity storage and transmission functions, time keeping functions, medical monitoring functions, loud speaker functions, vibration notification functions, light source functions, audio recording and playback functions, personal record and password storage, electronic payment facilitation applications, global position satellite (GPS) functions, and video and image capturing functions.

15. The electronic communication device of claim 13, which further comprises a light-emitting means.

16. The electronic communication device of claim 15, wherein the light-emitting means is a light-emitting diode.

17. The electronic communication device of claim 16, which further comprises a means for reversibly securing the communication module to the first jewelry component.

18. The electronic communication device of claim 17, wherein the means for reversibly securing the communication module to the first jewelry component is selected from the group consisting of snaps, latches, springs, threaded features, twist locks, bayonets, magnets, and friction fit elements.

19. The electronic communication device of claim 17, which further comprises a battery that may be charged through inductive energy transfer.

20. The electronic communication device of claim 17, wherein the first jewelry component comprises a back portion and an adorned front portion, which together enclose and encapsulate the communication module when secured thereto.
